(19) United States
(12) Patent Application Publication
(10) Pub. No.: US 2009/0307358 A1
(43) Pub. Date: Dec. 10, 2009

(54) Transmission of Data Between A Server and A Communicating Object

(75) Inventors: Stéphane Poujol, La Ciotat (FR); Xavier Berard, Cadolive (FR); Patrice Amiel, Aix-les-milles (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Gémenos (FR)

(21) Appl. No.: 12/298,675

(22) PCT Filed: Apr. 24, 2007
(86) PCT No.: PCT/EP2007/053969

§ 371 Date: Aug. 25, 2009

(30) Foreign Application Priority Data
Apr. 28, 2006 (FR) 0651534

(51) Int. Cl. G06F 15/16

(52) U.S. Cl. 709/228

(57) ABSTRACT

Transmission of data between a download server and a communicating object through a communications network is initiated by a registration server, by transmitting connection parameters received from the download server to the communicating object via a first data channel opened by a first agent of the communicating object after attaching the object to the network. As a function of the connection parameters, a second agent in the communicating object opens a second data channel to the download server so as to transmit the data therein. As long as the first data channel is open, other servers can initiate a transmission via the registration server.

The present invention relates to a transmission of data between a server and a communicating object, the transmission being initiated by the server without the emission of a short message of the SMS (Short Message Service) type.

A communicating object may be portable like a MMC (Multi-Media Card), or a SD (Secure Digital) or a UICC (Universal Integrated Circuit(s) Card) chip card. The UICC chip card is for example a card provided with a SIM (Subscriber Identity Module) application when the terminal receiving the card is a mobile connected to a network of the GSM/GPRS (Global System for Mobile communications/General Packet Radio Service) type, or a USIM (Universal Subscriber Identity Module), RUIM (Removable User Identity Module) or ISIM (IP Subscriber Identity Module) application, when the terminal receiving the card is a mobile operating in a Coded Division Multiple Access of the third generation (3GPP) of the UMTS (Universal Mobile Telecommunications System) or URTRAN (UMTS Terrestrial Radio Access Network) type, or of the third generation (3GPP2) of the CDMA 2000 type.

The data download server, also called OTA (Over The Air) card managing platform, includes software which makes it possible for the operator managing the radiocommunications network to manage the chip cards in the mobile terminals and to modify their contents. Such operations, at the operator's initiative and also called in a push mode, relate for example to the downloading of a file into predetermined cards of the card population managed by the operator, or the downloading or the erasing of a determined application, or the modification of data in a file or in a determined application in cards managed by the operator.

At present, to carry out an operation in push mode initiated by an operator of a radiocommunications network for mobiles, the data download server managed by the operator must transmit a short message currently called a “push SMS” in order to request each chip card targeted by the operation to open a communication channel of the IP (Internet Protocol) type between the card and the server.

The SMS technology required for placing the communication in push mode is a drawback for the radiocommunications network, the infrastructures of which do not support short messages or for which, short messages do not meet the standards required for a distant updating of cards for example, in CMDA radiocommunications network. In addition, the SMS technology is based on an asynchronous communication protocol, it requires many tests and sometimes results in a loss of the message and important loading time. If chip cards are unavailable in turned-off mobiles or mobiles outside the coverage of the radiocommunications network, numerous unsuccessful subsequent short messages sendings overload the network in a useless way.

Theoretical solutions for establishing communication channel without the transmission of push SMS remedy the above-mentioned drawbacks.

A first solution is described in the French patent application 0552365 filed on Jul. 28, 2005 by the applicant and not published. The first solution reverses the present push mode into a card interrogation mode which periodically initiates a communication with a campaign server in order to obtain contents if any, made available by the operator of the radiocommunications network during a download campaign.

A second solution relates to the GPRS specifications wherein, in theory, an OTA platform can open a communication channel to a chip card. In practice, the platform must know the addresses of all the chip cards managed by the platform which is costly and difficult to obtain if account is taken of the dynamic addressing of the cards. In addition, from the security point of view, any external entity to the chip card and knowing the card access address can open a communication channel with the card thus favorising external attacks. Thus, it is preferred in this case that the card controls the opening of the communication channel.

According to a third solution, the chip card includes applications dedicated to the opening of a communication channel in order to detect therein a possible request for connexion from the OTA platform. The OTA platform must then know the IP address of the card, which is not possible a priori in the case of a dynamic addressing. In addition, the card must open, as from the beginning of the monitoring of the request for connection, as many different communication channels as there are communication protocols to be managed. Then, it is no longer possible to open more communication channels than those initially provided by the card or to use different communication protocols from those for which the card initially opened a channel.

The aim of the invention is to remedy the above mentioned drawbacks and more particularly, to transmit data between at least one communicating object, such as a chip card, and a server such as a card managing platform, upon the initiative of the server without any transmission of a push SMS, while providing a previous availability of the communicating object for receiving data to be transmitted via a communication channel opened by the communicating object.

To reach this aim, a method for transmitting data between a first server means and at least a communicating object through a communications network, is characterised in that it includes the following steps:

opening a first data channel from the communicating object to a second sever means after attaching the communicating object to the communications network,

transmitting connection parameters from the first server means through the second server means and the first data channel to the communicating object, and

opening a second data channel from the communicating object to the first server means as a function of the connection parameters, in order to transmit data between the first server means and the communicating object through the second data channel.

The transmission of data according to the invention is thus advantageously initiated from a first download server means in the communications network which does not support the SMS technology.

The opening of the first data channel by the communicating object to the second server means has the advantage of indicating to the first and second server means that the communicating object is attached to the communications network and is thus ready for a transmission of data, in order to reduce the number of tests and thus optimise the duration of the download campaign.

In addition, the second data channel is opened depending on the connection parameters relating to the first server means retransmitted by the second server means. This dependence facilitates the opening of any applicative session according to any type of communication protocol, contrary to the previous technique in which the communicating object must open, as from its attachment to the network, as many different communication channels as there are communication protocols to be managed by the communicating object.

Upon the opening of the first data channel, the communicating object transmits to the second server means an identifier and an address of the communicating object, so that the second server means matches the identifier with the address in order to register the opening of the first data channel. The address of the communicating object may not be transmitted if it is already known by the second server means.

Another object of the invention is also a system for transmitting data between a first server means and at least a communicating object through a communications network. The system is characterised in that it includes:

means in the communicating object for opening a first data channel to a second server means after attaching the communicating object to the communications network,

means in the second server means for retransmitting connection parameters from the first server means through the first data channel to the communicating object, and

means in the communicating object for opening a second data channel towards the first server means as a function of the connection parameters, in order to transmit the data between the first server means and the communicating object through the second data channel.

The system of the invention does not require costly hardware modifications in the present infrastructures of the network. In addition, the system of the invention facilitates the deployment of the first server means as an OTA download platform in the network which no longer requires the integration of SMS technology equipment.

Virtual operators which do not have the SMS infrastructure may, thanks to the invention, launch updating campaigns to the communicating objects that they manage.

The invention further includes a communicating object adapted to the transmission of data between a first server means and said communicating object through a communications network. The communicating object is characterised in that it includes:

means for opening a first data channel towards a second server means after attaching the communicating object to the communications network, so that the first server means transmit connection parameters through the second server means and the first data channel towards the communicating object, and

means for opening a second data channel towards the first server means as a function of the connection parameters, in order to transmit data between the first server means and the communicating object through the second data channel.

The communicating object may be constituted by a chip card associated with a terminal, for example, a personal computer, a mobile or a communication personal assistant PDA, or be composed of a terminal.

Eventually, the invention relates to a computer program able to be implemented in a communicating object adapted to the transmission of data between a first server means and said communicating object through a communications network. The program includes instructions which, when the program is executed in said communicating object, carry out the steps according to the method of the invention.

Other characteristics and advantages of the present invention will appear more clearly upon reading the following description of several embodiments of the invention given as non limitative examples, and while referring to the appended drawings wherein:

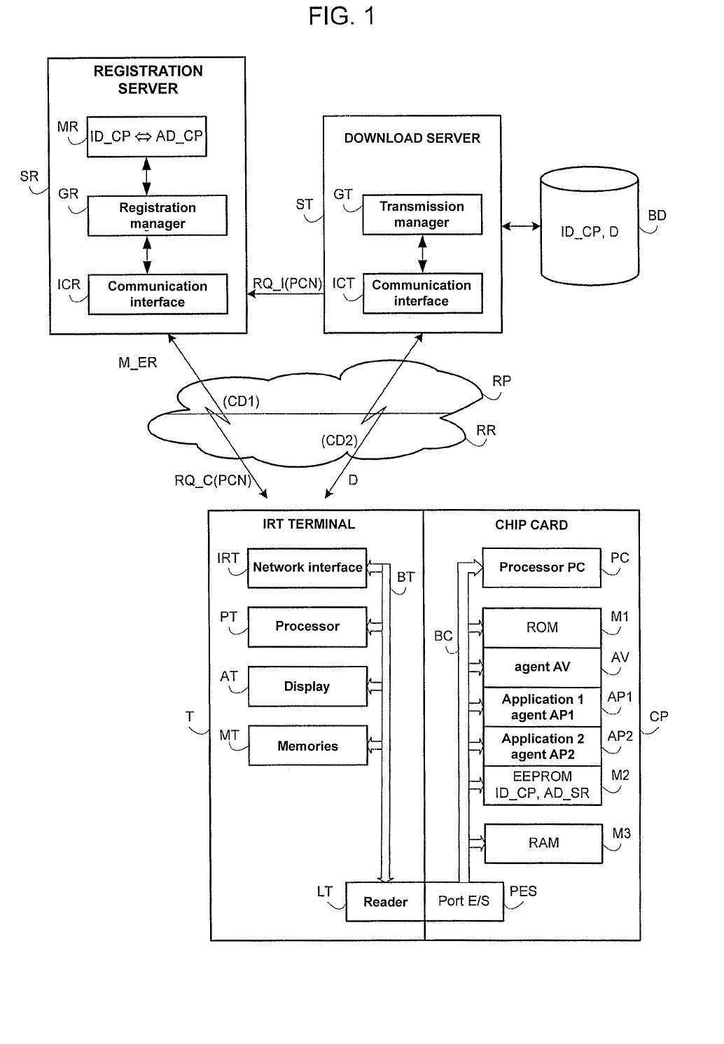

FIG. 1 is a schematic block diagram of a communication system connecting a communicating object, a registration server and a download server managed by a network operator, for the implementation of the data transmission method according to the invention; and

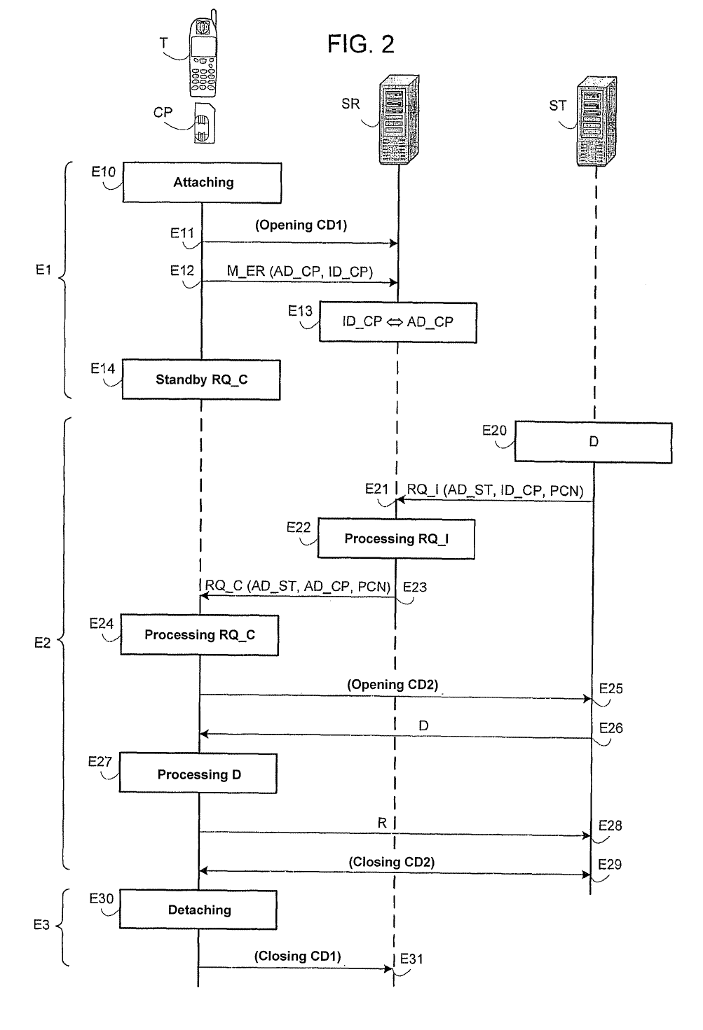

FIG. 2 is an algorithm of the data transmission method according to the invention.

In FIG. 1 are shown server means for transmitting or receiving data in or from at least one communicating object. According to an example which we will be referring to in the following, the communicating object is portable and is a chip card CP which is associated with a mobile radio terminal T, for example which is removable from the terminal. The chip card CP is of the UICC (Universal Integrated Circuit(s) Card) type. The chip card CP with the terminal T is connected to a cellular radiocommunications network RR of the GSM type, backed by a packet switching network with management of the mobility and access by radio channel GPRS or of the UMTS type, or of the third generation (3GPP2) of the CDMA 2000 type.

The server means are a download server ST and a registration server SR.

The download server ST is often managed by the operator of a radiocommunications network RR and constitutes an OTA (Over The Air) platform for downloading data towards the chip card targeted or not during a data downloading campaign or for a unitary data downloading. As a variant, the server ST constitutes a management platform of applications which are distributed between the server ST and the chip card CP and which exchange data. The server ST receives data from the chip card CP and vice versa.

The registration server SR registers the opening of the first permanent data channel CD1 between itself and the chip card CP. The opening of the first channel indicates that the card CP and the terminal T are attached to the cellular radiocommunications network RR. The opening of the first data channel CD1 is initiated by the chip card CP as soon as the mobile radio terminal T is turned on, being associated with the chip card CP and the attaching thereof to the radiocommunications network RR.

The registration server SR may also include a function for transmitting data and constituting a platform comprising data to be transmitted to or to be received from the chip card CP.

The download server ST and the registration server are communicating directly through a wire connection or through a high speed packet network RP, for example the Internet or the Intranet. In the first case, both servers ST and SR are positioned in a unique server managed by the same operator, thus reducing addressing constraints. In the second case, the two servers are localised at distinct operators' and thus communicate through a secure connection.

SR and ST servers communicate with the chip card CP associated with the terminal T through the data channels CD1 and CD2 opened between the radio communications network RR and the packet network RP through a communication gateway not shown in FIG. 1, for example. The communication gateway may include an access gateway for communicating with the servers SR and ST through the high speed packet network RP. Another access gateway of the communication gateway communicates with at least one switch of the radio communications network RR, often through an access network such as a packet network of the X.25 type or an RNIS (integrated services digital network) network or an ATM (Asynchronous Transfer Mode) network

According to a particular embodiment, the communication gateway exchanges with the mobile radio terminal T messages which encapsulate IP (Internet Protocol) packets transmitted to and by the servers SR and ST through the networks RR and RP.

When the download server ST wishes to download to or receive data from the chip card CP, it transmits a request for initiating the transmission RQ_I including connection parameters PCN to the registration server SR.

In the first data channel CD1, a request for connection RQ_C circulates from the registration server SR to the chip card CP in response to the request for initiating the download RQ_I by the server ST. Upon receiving the request for connection RQ_C, the card CP opens a second data channel CD2 between the download server ST and the chip card CP according to the connection parameters PCN requested by the download server ST. The data channel CD1 is opened according to the protocol of the IP (Internet Protocol) network and preferably according to a connectionless mode transport protocol which does not guarantee the arrival of packet such as the UDP (User Datagram Protocol) protocol. Such a transport protocol has the advantage of consuming little resources on the registration server SR and to remain opened in a permanent way. As a variation, the transport protocol of the channel CD1 is a connection mode protocol guaranteeing the arrival of packet such as a TCP (Transport Control Protocol) protocol which guarantees the checking of errors.

Upon the opening of the channel CD1, the chip card transmits a registration message M_ER to the registration server.

As soon as the terminal T is turned off, the card CP closes the data channel CD1.

In the radio communications network RR, the chip card CP communicates with the mobile radio terminal T according to a SCTP (Socket Card Transport Protocol) protocol, for example the BIP (Bearer Independent Protocol) protocol or through a dedicated application (Midlet) which is placed aboard the terminal which communicates with the card via a specific application protocol, such as for example a J2ME (Java 2 Mobile Edition) protocol. In the example of FIGS. 1 and 2, the terminal T does not processes the IP packets which transit between the servers and the chip card CP. The terminal T is transparent.

In a greater detail in FIG. 1, are shown the registration server SR, the download server ST, the terminal T and the chip card CP in the form of functional blocks, most of which carry out functions having a connection with the invention and may correspond with software and/or hardware modules.

The download server ST includes a download manager GT which manages various operations during the downloading and a communication interface ICT for transmitting and receiving IP packets through the packet network RP. The operations managed by the manager GT are more particularly the launching of the request for initiating the transmission RQ_I transmitted to the registration server SR in order to initiate an exchange of the chip card CP, and the sending to and/or the reception from the chip card CP of data via the second data channel CD2.

A database BD may be integrated in the download server ST, or be independent in the form of a database managing server which is connected to the server ST through a packet network such as the network RP, i.e. via the Internet or via an Intranet network belonging to the operator of the network RR. The database BD includes data D to be downloaded and various parameters and characteristics of the cards, including the card CP, managed by the operator of the cellular radio communications network RR. The database includes a fixed identifier ID_CP of the chip card which is for example the card series number and/or the international identity IMSI (International Mobile Subscriber Identity) of the card user and/or the phone number MSISDN (Mobile Station ISDN Number) of the terminal T user.

The registration server SR includes a manager GR which manages the registration of the opening of the first data channel CD1 between the chip card CP and the registration server SR. The registration consists, for example, in matching an address AD_CP of the chip card CP with the fixed identifier ID_CP of the chip card. Such matching is registered in a memory MR of the registration server. Other chip cards according to the invention are registered with the registration server as soon as the terminals associated with such cards are turned on and as from the opening of the first respective data channel.

According to a first embodiment, the registration server does not know the address AD_CP of the chip card CP. The latter is an address of the IP type dynamically allocated to the card by the network RR upon each attaching of the terminal T to the network. As a variation, the address AD_CP is a fixed address dedicated to the card CP and unknown to the server SR as long as the card has not opened the channel CD1 for the first time.

According to a second embodiment, the registration server already knows the address AD_CP of the IP type dynamically allocated to the card CP. The server SR may be a server of the radio communications network operator RR managing the chip card CP and the assignment of the address thereof AD_CP. As a variation, the address AD_CP is dynamically built as a function of a code, for example depending on identifiers of the chip card builder, the network RR operator and the card user. The registration server SR includes an algorithm encoding the address AD_CP of the chip card CP in the memory MR.

According to a third embodiment, the registration server knows the address AD_CP of the chip card which is a fixed address associated with the identifier ID_CP of the card.

The registration server SR also includes a communication interface ICR in order to exchange messages, requests and answers with the download server ST and the chip card CP.

The terminal T includes a network interface IRT, a processor PT, memories MT, a card reader LT and optionally a display AT such as a screen connected to or integrated in the terminal and associated more particularly with a keyboard connected to or integrated in the terminal. The various elements of the terminal are connected together by means of a bidirectional bus BT.

The chip card CP mainly comprises a processor PC, or several processors, and three memories M1 to M3. The card exchanges instructions, or requests, and answers with the terminal T through an input/output port PES and the reader LT with or without contact. The various card elements are connected together by a bidirectional bus BC.

The memory M1 is of the ROM or Flash type and includes the card operation system.

The memory M2 is a non-volatile memory for example an EEPROM or a Flash memory more particularly for storing keys, identification numbers and other parameters relating to the profile of the user owning the card, such as a PIN code and other safety data. The memory M2 also includes the fixed identifier ID_CP of the chip card, card applications and an address AD_SR of the registration server SR.

The memory M3 is a RAM or SRAM memory more particularly used for processing data.

The card CP includes, in addition and as regards the invention, a first software module also called standby agent AV (applet) distributed in the memories M1 and M2. When the terminal is turned on, the standby agent AV opens the first data channel CD1 between the chip card CP associated with the terminal and the registration server SR.

Other software modules are called application agent AP1 and agent AP2 and are dedicated to distinct respective transport protocols such as CAT-TP (Card Application Toolkit—Transport Protocol), FTP (File Transfer Protocol) and HTTP (Hypertext Transfer Protocol) protocols. When the card receives the request of connection RQ_C including the connection parameters PCN from the download server ST, an application agent, for example the agent AP1, is selected as a function of said connection parameters for opening the data channel CD2 in order to directly transfer data D between the download server ST and the chip card CP.

While referring to FIG. 2, the method of the invention is implemented in an existing network RR of the GSM/GPRS type including a dynamical assigner of chip card addresses and in a packet network RP, and includes main steps E1 to E3.

The main step E1 relates to the opening of the first permanent data channel CD1 and includes steps E10 to E14. After attaching the terminal T associated with the chip card CP to the network RR during step E10, for example, further to the turning on or under the coverage of the network of the terminal T or a connection of the card to the terminal, the terminal T associated with the chip card CP is attached to the network RR and the standby agent AV of the chip card reads the address AD_SR of the registration server in the memory M2 in order to open the data channel CD1 and establish a permanent connection via the data channel CD1 between the card and the registration server SR, during step E11. During step E12, after the opening of the data channel CD1, the standby agent AV transmits to the server SR a registration message M_ER including the fixed identifier ID_CP of the chip card CP so that the server SR registrates a matching of the identifier with an address AD_CP of the portable communicating object known to the server. In the embodiment where the server SR does not know the new address AD_CP dynamically allocated to the card CP by the network RR, the registration message M_ER further includes the fixed identifier ID_CP also the address AD_CP so as the server SR registrates a matching of the address unknown to the identifier.

During step E13, the registration server registrates in the memory MR, the opening of the data channel CD1 in the form of the matching of the address AD_CP with the identifier ID_CP of the chip card.

As a variation, when the server SR knows the card address, the steps E12 and E13 are optional.

During step E14, the standby agent AV of the chip card waits for the reception of a request for a connection C transmitted by the channel CD1.

The main step E2 relates to a download of data from a download server ST and includes steps E20 to E29.

During step E20, the operator of the radiocommunications network RR wishes to download data D into the chip card CP from the download server ST. During step E21, the manager GT of the download server ST makes a request for initiating the transmission RQ_I and transmits it via the interface ICT to the registration server SR. The request for initiating the transmission RQ_I includes more particularly the address AD_ST of the server ST, the identifier ID_CP of the chip card CP and the connection parameters PCN relating to the download server ST as those relating to the transport protocol CAT-TP on a TCP/IP link.

During step E22, the registration server SR receives the request for initiating RQ_I and processes it. As a function of the identifier ID_CP of the chip card which has been transmitted, the registration manager GR reads the address AD_CP associated with the identifier ID_CP from the memory MR in order to transmit, during step E23, a request for connection RQ_C containing the address AD_ST of the server ST, the connection parameters PCN and optionally the address AD_CP to the chip card CP via the opened channel CD1.

As soon as the card CP receives the request for connection RQ_C, the standby agent AV processes it and extracts therefrom the address AD_ST of the download server and the connection parameters PCN for communicating them to the application agent AP1 dedicated to the transport protocol CAT_TP. The application agent AP1 opens, during step E25, the second data channel CD2 as a function of the connection parameters PCN transmitted, so that the card CP communicates with the download server ST via the terminal T, without using the intermediate server SR.

During step E26, the download manager GT of the server ST downloads data D into the card CP which processes them during step E27, via the communication interface ICT and through the channel CD2. For example, the card updates an application relating to the downloading. Optionally, after the processing of data D, the card transmits, during step E28, the result R of the download to the server ST. Preferably, upon completion of the download, at the step E29, the card and/or the server ST release the data channel CD2.

As a variant of the main step E2, an application of the download server is adapted for receiving data supplied by the chip card CP. The download server ST transmits to the server SR a request RQ_I containing in addition to the parameters PCN and the addresses AD_ST and AD_CP, an identifier of the data requested by the server ST application.

The registration server SR receives the request RQ_I, processes it and transmits to the chip card a request for connection RQ_C containing in addition to the parameters PCN and the addresses AD_ST and AD_CP, the identifier of requested data via the opened channel CD1.

As soon as the card CP receives the request for connection RQ_C, it opens the second data channel CD2 as a function of the connection parameters PCN transmitted in order to communicate with the download server ST via the terminal T. without using the intermediate server SR. The chip card transmits the data requested to the download server which processes it through the channel CD2.

As long as the data channel CD1 is open, other download servers can initiate a download via the registration server SR. Thus, after downloading data D from the download server ST, or simultaneously, a second download server, also called hereinafter the third server, can also exchange data with the chip card CP in an analogous way to the main step E2 and its variation. The method of the invention thus includes, in addition to the opening E11 of the first data channel CD1, the following steps:

transmitting second connection parameters from the third server through the registration server SR and the data channel CD1 towards the chip card CP via the terminal T,

opening a third data channel from the chip card to the third server as a function of the second connection parameters, in order to transmit data between the third server and the chip card through the third data channel, and

closing the third data channel upon completion of the transmission of data.

The second connection parameters transmitted by the third server constituting the second download server can be different from the connection parameters of the server ST and are relative, for example, to an exchange of data according to the transport protocol FTP on a TCP/IP or UDP/IP link. In this case, the standby agent AV uses another application agent, for example the agent AP2 dedicated to the transport protocol FTP. The agent AP2 opens the third data channel other than the channels CD1 and CD2, according to the second connection parameters transmitted by the third server.

The registration server may also exchange data with the chip card CP in an analogous way to the download of data from the download servers. In this case, the steps E23 to E29 are the only one to be executed. A data channel other than the channel CD1 is opened depending on the connection parameters sent by the server SR in the request for connection RQ_C.

As long as the chip card is present in the network RR and is thus attached thereto, the data channel CD1 is open in order to process any request for connection RQ_C relating to the initiation of a transmission.

The main step E3 relates to the closing of channel CD1, when the terminal T ant the card CP are detached for the network RR at step E30 for example, further to the turning off or leaving the coverage of the terminal T or to a disconnection of the card and the terminal. The chip card closes the first data channel CD1 at step E31. The registration of the identifier ID_CP associated with the address AD_CP is deleted from the memory MR of the registration server SR by the registration manager GR.

The invention is not limited to the transmission of data between a server and chip cards of the UICC type. A chip card with which data are to be exchanged can also be a card included in a portable computer connected to the mobile terminal, a payment card, an electronic purse card, a health card, an electronic passport or any other additional card connected to a mobile terminal.

For example, the invention can be applied to payment cards targeted by a download campaign for which the data to be downloaded may relate to the change of name of the bank issuing said cards in the non volatile memory of the EEPROM type of the cards.

According to other variations, the invention can be applied to other portable communicating electronic objects, such as communicating personal digital assistants PDA.

The invention can also be used for giving the chip card a local access through a wire link such as through a USB (Universal Serial Bus) bus or through a short range wireless connection of the Bluetooth type, infrared type, according to a IEEE 802.xx standard, or meeting the WiFi (Wireless Fidelity) and the WIMAX (World wide Interoperability Microwave Access) label, so that a local entity initiates a download of data into the chip card. The local entity may be for example a personal computer (PC) connected to a chip card reader associated with the card or without any contact therewith.

The transmission system of the invention may also be implemented in a radiocommunications network including an infrastructure for managing short messages without modifying the method of the invention.

The invention described here relates to a method and a system for transmitting data between a download server and one or several portable communicating objects, as well as a communicating object adapted to transmit and receive data to or from first server means through a communications network. According to one implementation, the steps of the method of the invention may be determined by the instructions of a computer program integrated in the communicating object and including instructions which, when the program is executed in said communicating object, carry out the steps according to the method of the invention. According to another implementation, the steps of the method according to the invention may be determined by the instructions of a computer program incorporated in the system and in particular partially in the download server and partially in the registration server. The program includes program instructions which, when said program is downloaded and executed in the system, the operation of which is then controlled by the execution of the program, carry out the steps of the method according to the invention.

Consequently, the invention also applies to a computer program, more particularly a program in or on an information medium, adapted for implementing the invention.

1. A method for transmitting data between a first server and at least one communicating object through a communications network, which includes the following steps:
opening a first data channel from the communicating object to a second server after attaching the communicating object to the communications network,
transmitting connection parameters from the first server through the second server and the first data channel to the communicating object, and
opening a second data channel from the communicating object to the first server as a function of the connection parameters, in order to transmit data between the first server and the communicating object through the second data channel.

2. A method according to claim 1, wherein the first data channel is opened according to a connectionless mode transport protocol.

3. A method according to claim 1, further including, after the opening of the first data channel, the following steps:
transmitting second connection parameters from a third server through the second server and the first data channel to the communicating object, and
opening a third data channel from the communicating object to the third server as a function of the second connection parameters, in order to transmit data between the third sever and the communicating object through the third data channel.

4. A method according to claim 1, wherein, upon the opening of the first data channel, the communicating object transmits to the second server an identifier of the communicating object so that the second server registers the opening of the first data channel in the form of a matching of the identifier with an address of the communicating object recognized by the second server.

5. A method according to claim 1, wherein, upon the opening of the first data channel, the communicating object transmits to the second server an address dynamically allocated to the communicating object by the network and an identifier of the communicating object so that the second server registers the opening of the first data channel in the form of a matching of the address with the identifier.

6. A method according to claim 1, comprising a closing of the second data channel when the transmission of data is completed and a closing of the first data channel when the communicating object is detached from the communications network.

7. A system for transmitting data between a first server and at least a communicating object through a communications network, which includes:
means in the communicating object for opening a first data channel to a second server after attaching the communicating object to the communications network,
means in the second server for retransmitting connection parameters from the first server through the first data channel to the communicating object, and
means in the communicating object for opening a second data channel to the first server as a function of connection parameters, in order to transmit data between the first server and the communicating object through the second data channel.

8. A system according to claim 7, wherein the communications network includes a Coded Division Multiple Access network.

9. A communicating object adapted to the transmission of data between a first server and said communicating object through a communications network, which includes:
means for opening a first data channel to a second server after attaching the communicating object to a communications network so that the first server transmits connection parameters through the second server and the first data channel to the communicating object, and
means for opening a second data channel to the first server as a function of the connection parameters, in order to transmit data between the first server and the communicating through the second data channel.

10. A communicating object according to claim 9, composed of a chip card associated with a terminal.

11. A communicating object according to claim 9, composed of a mobile terminal.

12. A computer-readable medium containing program able to be implemented in a communicating object adapted to the transmission of data between a first server and said communicating object through a communications network, which includes instructions which, when the program is executed in said communicating object, carry out the following steps:
opening a first data channel from the communicating object to a second server after attaching the communicating object to the communications network so that the first server transmits connection parameters through the second server and the first data channel to the communicating object, and
opening a second data channel from the communicating object to the first server as a function of the connection parameters, in order to transmit data between the first server and the communicating object through the second data channel.

13. A method according to claim 2, further including, after the opening of the first data channel, the following steps:
transmitting second connection parameters from a third server through the second server and the first data channel to the communicating object, and
opening a third data channel from the communicating object to the third server as a function of the second connection parameters, in order to transmit data between the third sever and the communicating object through the third data channel.

14. A method according to claim 2, wherein, upon the opening of the first data channel, the communicating object transmits to the second server an identifier of the communicating object so that the second server registers the opening of the first data channel in the form of a matching of the identifier with an address of the communicating object recognized by the second server.

15. A method according to claim 3, wherein, upon the opening of the first data channel, the communicating object transmits to the second server an identifier of the communicating object so that the second server registers the opening of the first data channel in the form of a matching of the identifier with an address of the communicating object recognized by the second server.

16. A method according to claim 2, comprising a closing of the second data channel when the transmission of data is completed and a closing of the first data channel when the communicating object is detached from the communications network.

17. A method according to claim 3, comprising a closing of the second data channel when the transmission of data is completed and a closing of the first data channel when the communicating object is detached from the communications network.

18. A method according to claim 4, comprising a closing of the second data channel when the transmission of data is completed and a closing of the first data channel when the communicating object is detached from the communications network.

19. A method according to claim 5, comprising a closing of the second data channel when the transmission of data is completed and a closing of the first data channel when the communicating object is detached from the communications network.
